(19) United States
(12) Patent Application Publication
(10) Pub. No.: US 2024/0127000 A1
(43) Pub. Date: Apr. 18, 2024

(54) METHOD AND SYSTEM FOR TRAINING LARGE-SCALE LANGUAGE MODELS

(71) Applicant: HUAWEI TECHNOLOGIES CO., LTD., Shenzhen (CN)

(72) Inventors: Yichun Yin, Shenzhen (CN); Lifeng Shang, Hong Kong (CN); Cheng Chen, Shenzhen (CN); Xin Jiang, Hong Kong (CN); Xiao Chen, Hong Kong (CN); Qun Liu, Hong Kong (CN)

(21) Appl. No.: 17/958,080

(22) Filed: Sep. 30, 2022

(51) Int. Cl. G06F 40/40; G06N 3/08

(52) U.S. Cl. CPC G06F 40/40; G06N 3/08

(57) ABSTRACT

A computer-implemented method is provided for model training performed by a processing system. The method comprises determining a set of first weights based on a first matrix associated with a source model, determining a set of second weights based on the set of first weights, forming a second matrix associated with a target model based on the set of first weights and the set of second weights, initializing the target model based on the second matrix, and training the target model.

### TECHNICAL FIELD

This disclosure relates generally to machine learning technologies and, more specifically, to pre-training of neural network models. A published literature by Cheng Chen, Yichun Yin, Lifeng Shang, Xin Jiang, Yujia Qin, Fengyu Wang, Zhi Wang, Xiao Chen, Zhiyuan Liu, Qun Liu, titled “bert2BERT: Towards Reusable Pretrained Language Models,” (available at aclanthology.org/2022.acl-long.151) is in Appendix A, which is hereby incorporated by reference in its entirety. Appendix A provides reference to exemplary experimental setups and results through application of techniques in this disclosure and comparisons with prior art.

### BACKGROUND

Pre-trained language models (“PLMs”) are neural network models such as bidirectional encoder representations from transformers (“BERT”) and generative pre-training transformer (“GPT”). PLMs have achieved great success in natural language processing (“NLP”). Recently, there is a trend toward training extremely large models to explore the upper limits of PLMs. For example, large-scale PLMs, such as third generation GPTs (“GPT-3”) have about 175 billion (175 B) parameters, PanGu-α has about 200 B parameters, and switch transformers have about 1571 B parameters. All of these large-scale PLMs have proven to be promising tools in language understanding and generation.

However, large-scale PLMs are all independently pre-trained from scratch, without utilizing knowledge of smaller, already trained PLMs. The pre-training process of large-scale PLMs is computationally expensive and produces a large carbon footprint. For example, a GPT-3 PLM trained for 3.1×10⁶ graphics processing unit (“GPU”) hours results in an estimated cost of 4.6 million US dollars, thus consuming significant computing resources.

There is a need to develop solutions that reduce the training costs associated with large-scale PLMs, which will realize savings in the computational cost and resources.

### SUMMARY

In an exemplary embodiment, the present disclosure provides a method for model training, which is performed by a processing system. The method comprises: a) determining a set of first weights based on a first matrix associated with a source model, b) determining a set of second weights based on the set of first weights, c) forming a second matrix associated with a target model based on the set of first weights and the set of second weights, d) initializing the target model based on the second matrix, and e) training the target model.

In a further exemplary embodiment, the first matrix comprises weights associated with connections between nodes in a current layer and nodes in an upper layer in the source model. Determining a set of first weights based on a first matrix associated with a source model further comprises: sampling weights associated with the nodes in the current layer among the weights in the first matrix, determining the set of first weights based on the sampled weights associated with one node among the nodes in the current layer, and forming a first intermediate matrix based on the set of first weights and the first matrix. Determining a set of second weights based on the set of first weights is based on the intermediate matrix.

In a further exemplary embodiment, determining a set of second weights based on the set of first weights further comprises: sampling weights associated with the nodes in the upper layer among the weights in the first intermediate matrix, and determining the set of second weights based on the sampled weights associated with one node among the nodes in the upper layer. Forming a second matrix associated with a target model based on the set of first weights and the set of second weights further comprises: forming the second matrix based on the first intermediate matrix and the set of second weights.

In a further exemplary embodiment, the current layer is comprised in a multi-head attention (MHA) module in a transformer network, the nodes in the current layer are neurons for multiple attention heads.

In a further exemplary embodiment, a third matrix comprises weights associated with connections between the nodes in the upper layer and nodes in a third layer in the source model. The third layer is the next layer of the upper layer. The method further comprises: sampling weights associated with the nodes in the upper layer among the weights in the third matrix, determining a set of third weights based on the sampled weights associated with one node among the nodes in the upper layer, and forming a second intermediate matrix based on the set of third weights and the third matrix.

In a further exemplary embodiment, determining a set of second weights based on the set of first weights further comprises: sampling weights associated with the nodes in the third layer among the weights in the second intermediate matrix, and determining the set of second weights based on the sampled weights associated with one node among the nodes in the third layer. Forming a second matrix associated with a target model based on the set of first weights and the set of second weights further comprises: forming the second matrix based on the first intermediate matrix and the set of second weights.

In a further exemplary embodiment, the method further comprises: f) generating multiple copies of the second matrix by duplicating the second matrix multiple times. Initializing the target model based on the second matrix further comprises: initializing the target model using the multiple copies of the second matrix.

In a further exemplary embodiment, the method further comprising: obtaining the multiple copies of the second matrix of target dimensions for the target model by carrying out multiple iterations of a), b), c), and f)

In a further exemplary embodiment, the first matrix is associated with one module among a plurality of modules in the source model. The method further comprises: forming, by carrying out multiple iterations of a) through c), a second matrix associated with each of the other modules among the plurality of models in the source model.

In a further exemplary embodiment, the trained target model is used as a second source model to initialize a second target model.

In a further exemplary embodiment, training the target model further comprises: determining a plurality of sub-models based on the target model, updating a plurality of layers in the target model by training the plurality of sub-models, and training the target model to update the plurality of layers thereof. The target model comprises the plurality of layers and each sub-model is used for updating a subset of layers among the plurality of layers in the target model.

In a further exemplary embodiment, updating the plurality of layers in the target model by training the plurality of sub-models further comprises: sampling the plurality of sub-models, training the sampled sub-model by using a training dataset, and updating a corresponding subset of layers among the plurality of layers in the target model.

In a further exemplary embodiment, each of the plurality of sub-models comprises all or part of the plurality of layers in the target model. The subset of layers in the corresponding sub-model is a portion or all of the layers in the corresponding sub-model. Training the sampled sub-model by using a training dataset further comprises: computing a training loss based on the training dataset by using all of the layers in the corresponding sub-model, and updating the subset of layers in the corresponding sub-model based on the training loss.

In another exemplary embodiment, the present disclosure provides a system for model training. The system comprises one or more processors and a non-transitory computer-readable medium having computer-executable instructions stored thereon. The computer-executable instructions, when executed by one or more processors, causing the one or more processors to facilitate: a) determining a set of first weights based on a first matrix associated with a source model, b) determining a set of second weights based on the set of first weights, c) forming a second matrix associated with a target model based on the set of first weights and the set of second weights, d) initializing the target model based on the second matrix, and e) training the target model.

In a further exemplary embodiment, the first matrix comprises weights associated with connections between nodes in a current layer and nodes in an upper layer in the source model. Determining a set of first weights based on a first matrix associated with a source model further comprises: sampling weights associated with the nodes in the current layer among the weights in the first matrix, determining the set of first weights based on the sampled weights associated with one node among the nodes in the current layer, and forming a first intermediate matrix based on the set of first weights and the first matrix. Determining a set of second weights based on the set of first weights is based on the intermediate matrix.

In a further exemplary embodiment, determining a set of second weights based on the set of first weights further comprises: sampling weights associated with the nodes in the upper layer among the weights in the first intermediate matrix, and determining the set of second weights based on the sampled weights associated with one node among the nodes in the upper layer. Forming a second matrix associated with a target model based on the set of first weights and the set of second weights further comprises: forming the second matrix based on the first intermediate matrix and the set of second weights.

In a further exemplary embodiment, a third matrix comprises weights associated with connections between the nodes in the upper layer and nodes in a third layer in the source model. The third layer is the next layer of the upper layer. The one or more processors further facilitate: sampling weights associated with the nodes in the upper layer among the weights in the third matrix, determining a set of third weights based on the sampled weights associated with one node among the nodes in the upper layer, and forming a second intermediate matrix based on the set of third weights and the third matrix.

In a further exemplary embodiment, determining a set of second weights based on the set of first weights further comprises: sampling weights associated with the nodes in the third layer among the weights in the second intermediate matrix, and determining the set of second weights based on the sampled weights associated with one node among the nodes in the third layer. Forming a second matrix associated with a target model based on the set of first weights and the set of second weights further comprises: forming the second matrix based on the first intermediate matrix and the set of second weights.

In a further exemplary embodiment, training the target model further comprises: determining a plurality of sub-models based on the target model, updating a plurality of layers in the target model by training the plurality of sub-models, and training the target model to update the plurality of layers thereof. The target model comprises the plurality of layers and each sub-model is used for updating a subset of layers among the plurality of layers in the target model.

In yet another exemplary embodiment, the present disclosure provides a non-transitory computer-readable medium having processor-executable instructions stored thereon for model training. The computer-executable instructions, when executed by one or more processors, cause the one or more processors to facilitate: a) determining a set of first weights based on a first matrix associated with a source model, b) determining a set of second weights based on the set of first weights, c) forming a second matrix associated with a target model based on the set of first weights and the set of second weights, d) initializing the target model based on the second matrix, and e) training the target model.

### BRIEF DESCRIPTION OF THE DRAWINGS

The system and method for data processing are described in detail below with reference to the attached drawing figures, wherein:

FIG. 1A illustrates an exemplary network environment, in accordance with one or more examples of the present disclosure.

FIG. 1B illustrates an exemplary computer system, in accordance with one or more examples of the present disclosure.

FIG. 2A demonstrates an exemplary BERT model architecture, in accordance with one or more examples of the present disclosure.

FIG. 2B demonstrates an exemplary process of training a target model based on a trained source model, in accordance with one or more examples of the present disclosure.

FIG. 3A is an exemplary process of expanding a first parameter matrix associated with the source model to generate a second parameter matrix associated with the target model.

FIG. 3B is an exemplary process of expanding a first parameter matrix associated with the source model to generate a second parameter matrix associated with the target model.

FIG. 4 is an exemplary process of training a target model based on a source model, in accordance with one or more examples of the present disclosure.

FIG. 5 is a flowchart of performing expansions via FPI on various functional modules in a BERT model, in accordance with one or more examples of the present disclosure.

FIG. 6 is a flowchart of performing expansions via AKI on various functional modules in the BERT model as shown in FIG. 5, in accordance with one or more examples of the present disclosure.

FIG. 7 is an exemplary process of training a target model by implementing two-stage training, in accordance with one or more examples of the present disclosure.

### DETAILED DESCRIPTION

Embodiments of the present disclosure provide efficient training methods, which can be applied in various scenarios to train large-scale PLMs to perform a variety of tasks, such as search engines, dialogue systems, advertising and machine translation applications, etc. The methods of the present disclosure may address the issues that the pre-training process of large-scale PLMs is computationally expensive and produces huge carbon footprints, by significantly reducing computational cost for the training process. Therefore, the methods of the present disclosure may provide great value for a wide range of machine learning applications, such as NLP.

In an embodiment, a method is provided for initializing a target model using learned knowledge from a trained smaller model. In the present disclosure, the size of a model is associated with the number of weights in the layers of the respective model. The method may be used to expand the learned weight matrices from the smaller model in width and/or depth, so that the expanded weight matrices can provide sufficient weights to initialize the target model. In one example, the method may expand knowledge of each layer in the smaller model based on knowledge of the current layer. In another example, the method may expand knowledge of each layer in the smaller model based on the knowledge of multiple layers. For instance, the multiple layers may include the current layer and an upper layer with advanced knowledge (e.g., the layer after the current layer).

In another embodiment, another method is provided for training a target model. The method may be applied to train the target model in multiple stages. First, the method may be applied to generate multiple sub-models based on the target model and train the multiple sub-models, thereby reducing the computational complexity of training each sub-model. In some instances, the method may exploit the power of parallel computing to train sub-models in parallel. Second, the method may utilize the learned weights from the sub-models to train the target model.

Previous work has explored techniques for efficient pre-training of neural network models. Some work proposes progressive learning to accelerate the pre-training, which is motivated by the fact that different layers have some similar knowledge (e.g., attention patterns). This approach first pre-trains a small model with fewer transformer layers, and then iteratively expands the model by stacking the already trained layers, such that a larger model with expanded depth can be achieved. However, the approach is limited to depth-wise expansion of the model. Some other work proposes to “back distill” knowledge from small models into large models. This approach is also known as knowledge inheritance, which uses knowledge of small models to update some of the parameters/weights in large models. Still other work focuses on data efficiency and takes note of rarely used words during the pre-training process, so that the model learns to understand rarely used words as they next appear. In yet another work, an Enhanced Light Efficiency Cophasing Telescope Resolution Actuator (“ELECTRA”) model performs a task of replaced token detection to predict whether each token in the input is replaced or not, thereby improving the pre-training efficiency.

The present disclosure provides techniques that enable efficient and cost-effective training of neural network models. Those skilled in the art will appreciate that the techniques described in the present disclosure may be performed alone or in combination with existing techniques to improve the training process.

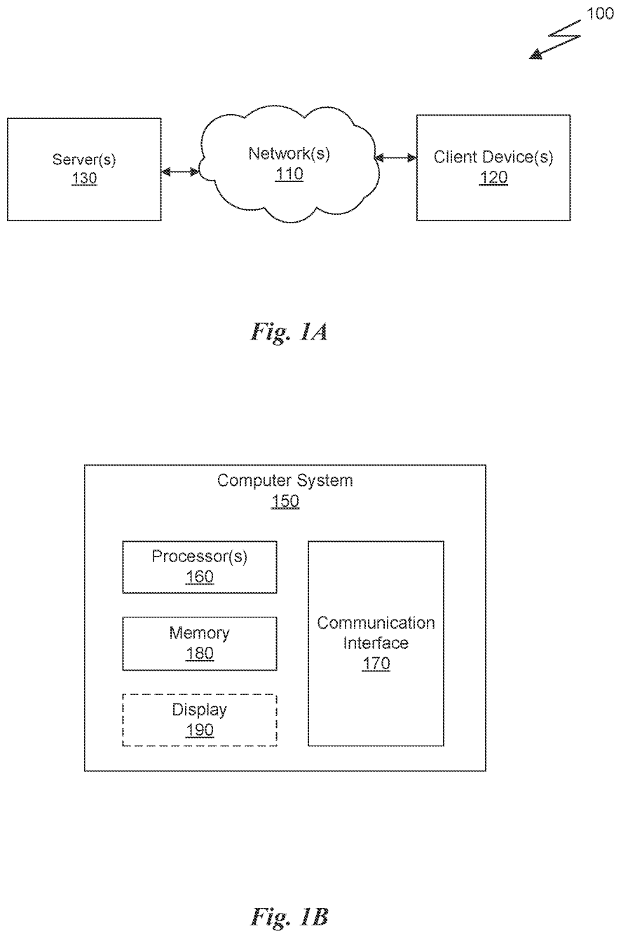

FIG. 1A illustrates an exemplary network environment 100, in accordance with one or more examples in the present disclosure. Machine learning techniques implementing the framework disclosed herein may take place in the exemplary network environment 100. Network environments suitable for use in implementing embodiments of the disclosure may include one or more client devices 120, servers 130, and/or other device types.

Components of a network environment may communicate with each other via a network(s) 110, which may be wired, wireless, or both. By way of example, network 110 may include one or more Wide Area Networks (“WANs”), one or more Local Area Networks (“LANs”), one or more public networks such as the Internet, and/or one or more private networks. Where the network includes a wireless telecommunications network, components such as a base station, a communications tower, access points, or other components may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (“APIs”)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). A cloud-based network environment may be private (e.g., limited to a single organization), may be public (e.g., available to many organizations), and/or a combination thereof (e.g., a hybrid cloud environment).

Client device(s) 120 may include at least some of the components, features, and functionality of the example computer system 150 of FIG. 1B. By way of example and not limitation, a client device 120 may be embodied as a Personal Computer (“PC”), a laptop computer, a mobile device, a smartphone, a tablet computer, a virtual reality headset, a video player, a video camera, a vehicle, a virtual machine, a drone, a robot, a handheld communications device, a vehicle computer system, an embedded system controller, a workstation, an edge device, any combination of these delineated devices, or any other suitable device.

FIG. 1B illustrates a block diagram of an exemplary computer system 150 configured to implement various functions according to one or more embodiments in the present disclosure. In some examples, computer system 150 may be implemented in client device 120 or server 130 in network environment 100 as shown in FIG. 1A. One or more computing systems 150, one or more client devices 120, one or more servers 130, or the combination thereof may form a processing system to perform the processes in the present disclosure.

As shown in FIG. 1B, computer system 150 may include one or more processors 160, a communication interface 170, a memory 180, and a display 190. Processor(s) 160 may be configured to perform the operations in accordance with the instructions stored in memory 180. Processor(s) 160 may include any appropriate type of general-purpose or special-purpose microprocessor (e.g., a CPU or GPU, respectively), digital signal processor, microcontroller, or the like. Memory 180 may be configured to store computer-readable instructions that, when executed by processor(s) 160, can cause processor(s) 160 to perform various operations disclosed herein. Memory 180 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM. Various processes/flowcharts described in terms of mathematics in the present disclosure may be realized in instructions stored in memory 180, when executed by processor(s) 160.

Communication interface 170 may be configured to communicate information between computer system 150 and other devices or systems, such as client device 120 and/or server 130 as shown in FIG. 1A. For example, communication interface 170 may include an integrated services digital network (“ISDN”) card, a cable modem, a satellite modem, or a modem to provide a data communication connection. As another example, communication interface 170 may include a local area network (“LAN”) card to provide a data communication connection to a compatible LAN. As a further example, communication interface 170 may include a high-speed network adapter such as a fiber optic network adaptor, 10G Ethernet adaptor, or the like. Wireless links can also be implemented by communication interface 170. In such an implementation, communication interface 170 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

Communication interface 170 may also include various I/O devices such as a keyboard, a mouse, a touchpad, a touch screen, a microphone, a camera, a biosensor, etc. A user may input data to computer system 150 (e.g., a terminal device) through communication interface 170.

Display 190 may be integrated as part of computer system 150 or may be provided as a separate device communicatively coupled to computer system 150. Display 190 may include a display device such as a liquid crystal display (“LCD”), a light emitting diode display (“LED”), a plasma display, or any other type of display, and provide a graphical user interface (“GUI”) presented on the display for user input and data depiction. In some embodiments, display 190 may be integrated as part of communication interface 170.

The application of the methods may be extended to any suitable type of deep neural network (DNN) models. A DNN model includes multiple layers of interconnected nodes (e.g., perceptrons, neurons, etc.) that can be trained with enormous amounts of input data to quickly solve complex problems with high accuracy. The first layer in the DNN model, which receives input to the DNN model, is referred to as the input layer. The last layer in the DNN model, which produces outputs of the DNN model, is referred to as the output layer. Any layer between the input layer and the output layer of the DNN model is referred to as the hidden layer. The parameters/weights related to the DNN model may be stored in memory 180 of a processing system in the form of a data structure.

The goal is to achieve accelerated and more cost-efficient pre-training of a target model by utilizing knowledge of a pre-trained source model. The dimension of the target/source model may be represented by two variables L and D. L is the number of layers (e.g., transformer layers) in the respective model, and D is the width of the model, which indicates hidden size, i.e., the number of features of the hidden states in the network. To this end, the target model may be represented by [symbol] (L^{t}, D^{t}) and the source model may be represented by [symbol] (L^{s}, D^{s}). The source model has a dimension that is smaller than the dimension of the target model, that is L^{s}<L^{t}, and D^{s}≤D^{t}. The goal may be achieved by performing (1) initialization of the target model [symbol] based on the knowledge of the source model [symbol] , (2) a multi-stage pre-training process, or the combination thereof.

The following describes an exemplary framework and demonstrates an exemplary process of training a DNN model by implementing the technique disclosed in the present disclosure. It should be noted that the framework and the process are described solely for illustration purposes and are not intended to limit the present disclosure. It will be appreciated by one skilled in the art that the framework and the process may be extended to any suitable neural network models in any suitable machine learning applications.

In this example, the processing system may be used to train a BERT model to process textual content. The input to the BERT model may be a sequence of tokens, which represent elements in the input textual content. For example, a token may be an instance of a sequence of characters (e.g., related to a word) in a sentence, which are grouped together as a useful semantic unit for processing.

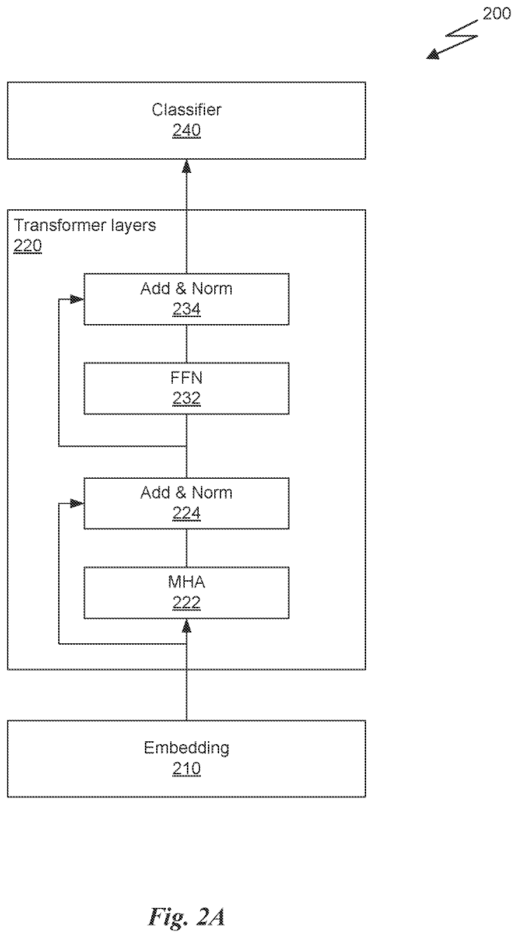

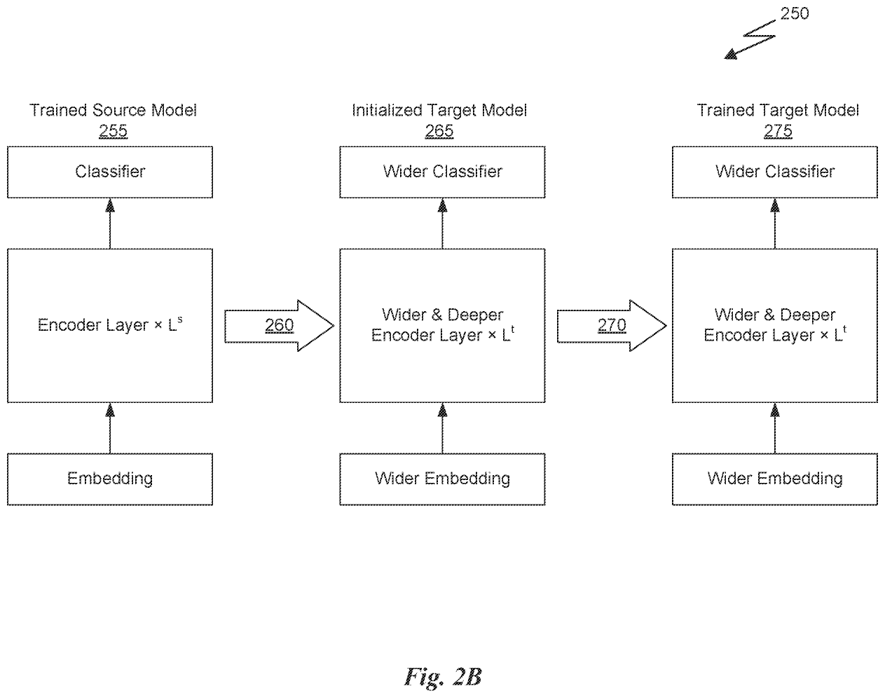

FIG. 2A demonstrates an exemplary BERT model architecture 200. Both the source and target models may have the model architecture 200 as shown in FIG. 2A, but in different dimensions. The source/target model may be stored in memory 180 in a processing system, which may include one or more computer systems 150 as illustrated in FIG. 1B. One or more computer systems 150 in the processing system may be embodied as one or more client devices 120, one or more servers 130, or a combination thereof in network environment 100 as depicted in FIG. 1A. Processer(s) 160 in the processing system may execute instructions stored in memory 180 to perform operations to the source/target model stored therein. The BERT model may include an embedding layer 210, a plurality of transformer layers 220, and a classifier layer 240. Embedding layer 210 converts each token into a fixed length vector of defined size. The elements in the vector indicate correlation between the respective token and other tokens in the batch, such that the knowledge of the vectors in the batch is limited by the size of the vector. That said, the resultant vector represents the respective token with reduced dimensions. The vectors associated with the tokens may form a weight matrix referred to as an embedding matrix W^{E}, where E denotes the embedding layer. Elements in the embedding matrix W^{E} are referred to as weights/parameters, which measure the degree of correlation between the tokens. The vectors associated with the tokens may correspond to rows/columns in the embedding matrix W^{E}.

A normalization layer may be set after embedding layer 210 to generate hidden states based on the output of the embedding layer. In initialization, the normalization layer may generate initial values for the hidden states, which are denoted as H₀. The hidden states may be iteratively processed by transformer layers 220 as follows:

Hₗ=Transformerₗ(Hₗ₋₁),l∈[1,L], (Eq. 1)

where L denotes the number of transformer layers 220. As shown in FIG. 2A, each transformer layer may include a multi-head attention (MHA) module 222, a feed-forward network (FFN) 232 and one or more other modules (e.g., 224 and 234) to perform summation and/or normalization to generate aggregated outputs of preceding modules/layers.

MHA module 222 may include multiple parallel attention heads (i.e., attention mechanisms). The BERT model may use MHA module 222 to learn relationships between the tokens. For instance, each token may focus on distinct aspects of other tokens via the multiple parallel attention heads in MHA module 222 in each transformer layer. As such, the BERT model may capture a broad range of relationships between the tokens via the plurality of transformer layers 220. The knowledge of the BERT model may be broadened by increasing the number of attention heads in MHA module 222 in each transformer layer. Attention heads implemented in the BERT model may be of various types, including but not limited to self-attention heads. Self-attention (head), also called intra-attention, is an attention mechanism relating different positions of a single sequence (e.g., words/tokens in a sentence) in order to compute a representation of the same sequence. Self-attention has been shown to be very useful in machine reading, abstractive summarization, or image description generation. To illustrate in this example, the BERT model includes self-attention heads in MHA module 222.

The hidden states Hₗ₋₁ from the preceding layer may be fed into each of the self-attention heads in MHA module 222. The i^{th} attention head may be represented by three parameter vectors (Qᵢ, Kᵢ, Vᵢ), where Qᵢ denotes queries, Kᵢ denotes keys, and Vᵢ denotes values. The queries, keys, and values may be computed as linear projections from the input hidden states Hₗ₋₁ by applying the following formula,

Qᵢ=Hₗ₋₁W_{l,i}^{Q}, (Eq. 2a)

Kᵢ=Hₗ₋₁W_{l,i}^{K}, (Eq. 2b)

Vᵢ=Hₗ₋₁W_{l,i}^{V}, (Eq. 2c)

where l denotes the l^{th} transformer layer, and W_{l,i}^{Q}, W_{l,i}^{K}, and W_{l,i}^{V} are matrices of learnable weights, which are associated with the l^{th} transformer layer and the i^{th} attention head. A context-aware vector may be obtained by computing a scaled dot-product of queries and keys in the i^{th} attention head, which may be used to compute the final output of the i^{th} attention head as:

$${H}_{l , i}^{HEAD} = softmax ( \frac{{Q}_{i} {K}_{i}^{T}}{\sqrt{{d}_{k}}} ) {V}_{i} {W}_{l , i}^{Q} , \qquad ( Eq . 3 )$$

where W_{l,i}^{O} denotes a parameter matrix associated with the l^{th} transformer layer and the i^{th} attention head, which includes learnable weights. dₖ is the head dimension for queries and keys, and \sqrt{dₖ} is a scaling factor. The softmax( ) function regularizes each row of the re-scaled product

$$\frac{{Q}_{i} {K}_{i}^{T}}{\sqrt{{d}_{k}}} .$$

Then, all heads in MHA module 222 in the l^{th} transformer layer may be summed to obtain an aggregated result of MHA module 222 by applying:

MHA(Hₗ₋₁)=Σᵢ₌₁^{α}H_{l,i}^{HEAD}, (Eq. 4a)

where a is the number of self-attention heads in MHA module 222.

As shown in FIG. 2A, module 224 may further aggregate the output of MHA module 222 with the input of MHA module 222, by applying:

Hᵢ^{MHA}=LayerNorm(Hₗ₋₁+MHA(Hₗ₋₁)). (Eq. 4b)

The calculated results Hₗ^{MHA} as shown in Equation 5 may be fed into FFN 232. FFN 232 may include one or more layers of learnable weights, which may be trained for additional processes of results from MHA module 222, such as residual connection and layer normalization processes. For instance, FFN module 232 may include two linear layers and one Gaussian error linear units (“GeLU”) activation function. The process performed by FFN 232 may be formulated as:

Hₗ^{FFN}=GeLU(Hₗ^{MHA}Wₗ¹+bₗ¹)Wₗ²+bₗ², (Eq. 5a)

where Wₗ¹ and Wₗ² are weight matrices including learnable weights, and bₗ¹ and bₗ² are bias vectors. Module 234 may further aggregate the output of FFN 232 with the output of MHA module 222, formulated as:

Hₗ=LayerNorm(Hₗ^{MHA}+Hₗ^{FFN}). (Eq. 5b)

Each of MHA module 222 and FFN 232 may implement layer normalization (“LN”), which is used to stabilize the dynamics of the hidden states in transformer layers 220. Formally, the LN process is formulated as:

$$LayerNorm ( H ) = ( \frac{H - {μ}_{H}}{{σ}_{H}} ) ⊙ {W}^{LN} + {b}^{LN} , \qquad ( Eq . 6 )$$

where ⊙ indicates element-wise multiplication, μ_{H} and σ_{H} are statistics of the hidden states H, which are the mean and variance of H, respectively. In some examples, transformer layers 220 in the BERT model may form multiple layers of encoder or decoder in any suitable applications. Classifier module 240 may receive the hidden states from transformer layers 220 and then generate classifications for the tokens.

FIG. 2B demonstrates an exemplary process 250 of training a target model based on a trained source model 255, in accordance with one or more examples of the present disclosure. Process 250 may be performed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform process 250. Process 250 may be performed alone or in combination with other processes in the present disclosure. It will be appreciated by one skilled in the art that process 250 may be performed in any suitable environment and blocks in process 250 may be performed in any suitable order.

The target model may be trained on the same or similar tasks as trained source model 255, so that knowledge of trained source model 255 may be utilized to accelerate the learning process of the target model. In some instances, the target model may be trained on the same or similar training datasets as trained source model 255. As shown in FIG. 2B, source model 255 includes L^{s} number of encoder layers. Block 260 indicates a first step of transferring knowledge from source model 255 to a target model for initialization. For example, the dimension of the source model may be expanded by generating additional nodes in each module/layer, generating additional layers in the source model, or the combination thereof. As a result, an initialized target model 265 may be obtained, which includes L^{t} number of wider and deeper encoder layers combined with wider embedding and classifier layers. Block 260 indicates a second step of training initialized target model 265 to obtain trained target model 275. In some variations, the width-wise expansion can be decomposed into expansions of parameter matrices and/or vectors.

Source model ( [symbol] ) 255 may be associated with one or more parameter matrices, which may include weights associated with interconnections between nodes in adjacent layers in the source model. A parameter matrix associated with the source model may be represented by W∈ [symbol] ^{d}^{ᵢₙ}^{^{w}}^{*d}^{ₒᵤₜ}^{^{w}}. Similarly, target model ( [symbol] ) may be associated with one or more parameter matrices, which may include weights associated with interconnections between nodes in adjacent layers in the target model. A parameter matrix associated with the source model may be represented by U∈ [symbol] ^{d}^{ᵢₙ}^{^{u}}^{*d}^{ₒᵤₜ}^{^{u}}. The parameter matrix W associated with the source model may be expanded to generate the parameter matrix U for the target model by applying width-wise expansions and/or depth-wise expansions. Width-wise expansions may be applied to generate a “wider” model, while depth-wise expansions may be applied to stack the wider model to increase the depth of the generated model. In some examples, width-wise expansions may include in-dimension expansions, out-dimension expansions, or the combination thereof. In-dimension is associated with arrow connections from one node in a current layer to nodes in the next layer. Out-dimension is associated with arrow connections from the nodes in the current layer to one node in the next layer. That said, W(i, j) indicates a parameter element in the parameter matrix W, where i and j refer to the i^{th} in-dimension index and the j^{th} out-dimension index, respectively. In an in-dimension expansion, an index mapping function gᵢₙ may be applied to the parameter matrix W to generate one or more parameters in the parameter matrix U. For instance, gᵢₙ(i) uses the gᵢₙ(i) -th in-dimension parameter of parameter matrix W to generate the i^{th} in-dimension parameter of the parameter matrix U. gₒᵤₜ(j) uses the gₒᵤₜ(j)-th out-dimension parameter of parameter matrix W to generate the j^{th} out-dimension parameter of the parameter matrix U.

In an example, the processing system may use a set of index mapping functions gᵢₙ and gₒᵤₜ to achieve function preserving initialization (FPI). FPI aims to ensure that the initialized target model has the same function as the source model, i.e., given the same input, the initialized target model produces the same output as the source model. Formally, the mapping functions gᵢₙ and gₒᵤₜ may be defined as follows:

$$\begin{matrix}{g}_{in} ( i ) = \{ \begin{matrix}i & i ∈ [ 1 , {d}_{in}^{w} ] \\ f ( \{ 1 , 2 , … , {d}_{in}^{w} \} ) & i ∈ ( {d}_{in}^{w} , {d}_{in}^{u} ]\end{matrix} , & ( Eq . 7 a ) \\ {g}_{out} ( i ) = \{ \begin{matrix}i & i ∈ [ 1 , {d}_{out}^{w} ] \\ f ( \{ 1 , 2 , … , {d}_{out}^{w} \} ) & i ∈ ( {d}_{out}^{w} , {d}_{out}^{u} ]\end{matrix} , & ( Eq . 7 b )\end{matrix}$$

where ƒ(⋅) is a function performing uniform sampling, the superscript “w” represents a parameter matrix W associated with the source model, the superscript “u” represents a parameter matrix U associated with the target model, and the subscripts “in” and “out” represent in-dimension and out-dimension, respectively. In this way, additional weights with indices i∈(dᵢₙ^{w}, dᵢₙ^{u}] and j∈(dₒᵤₜ^{w}, dₒᵤₜ^{u}] can be generated, which are associated with the added nodes to the source model. The weight expansion of the parameter matrix may be expressed as,

U=EXPN(;gᵢₙ,gₒᵤₜ), (Eq. 8)

The weight expansion as defined by Equation 8 may include in-dimension expansions related to Equations 9a and 9b and out-dimension expansions related to Equation 9c, which are formulated as follows:

$$\begin{matrix}{C}_{{g}_{in} ( i )} = {\sum }_{{i}^{′} = 1}^{{d}_{in}^{u}} 𝕀 ( {g}_{in} ( {i}^{′} ) = {g}_{in} ( i ) ) , & ( Eq . 9 a ) \\ {\tilde{U}}_{( i , \text{*)}} = \frac{1}{{C}_{{g}_{in} ( i )}} {W}_{( {g}_{in} ( i ) , \text{*)}} , & ( Eq . 9 b ) \\ {U}_{\text{(*} , j )} = {\tilde{U}}_{\text{(*} , {g}_{out} ( j ) )} , & ( Eq . 9 c )\end{matrix}$$

where [symbol] (⋅) is an indicator function, C_{g}_{ᵢₙ}₍ᵢ₎ is the count of gᵢₙ(i) in the values of gᵢₙ(χ). C_{g}_{ᵢₙ}₍ᵢ₎ may be used to re-scale the original parameters (e.g., the weights in the parameter matrix W) to maintain the function preserving property of the expanded parameter matrix (e.g., the parameter matrix U). Ũ represents an intermediate parameter matrix, which is a result of applying in-dimension expansion(s) to the parameter matrix W.

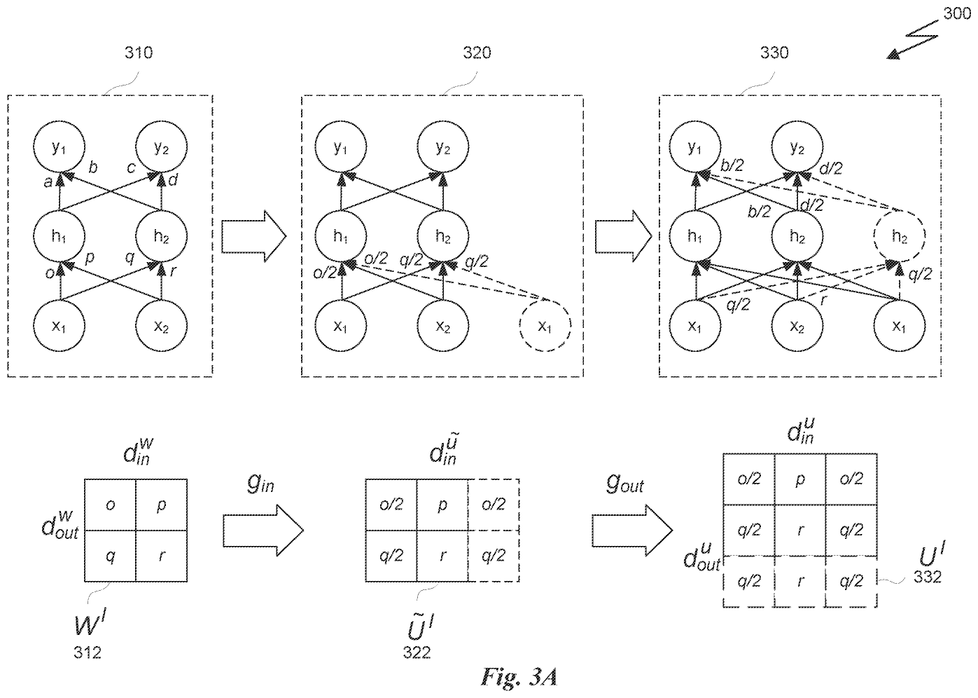

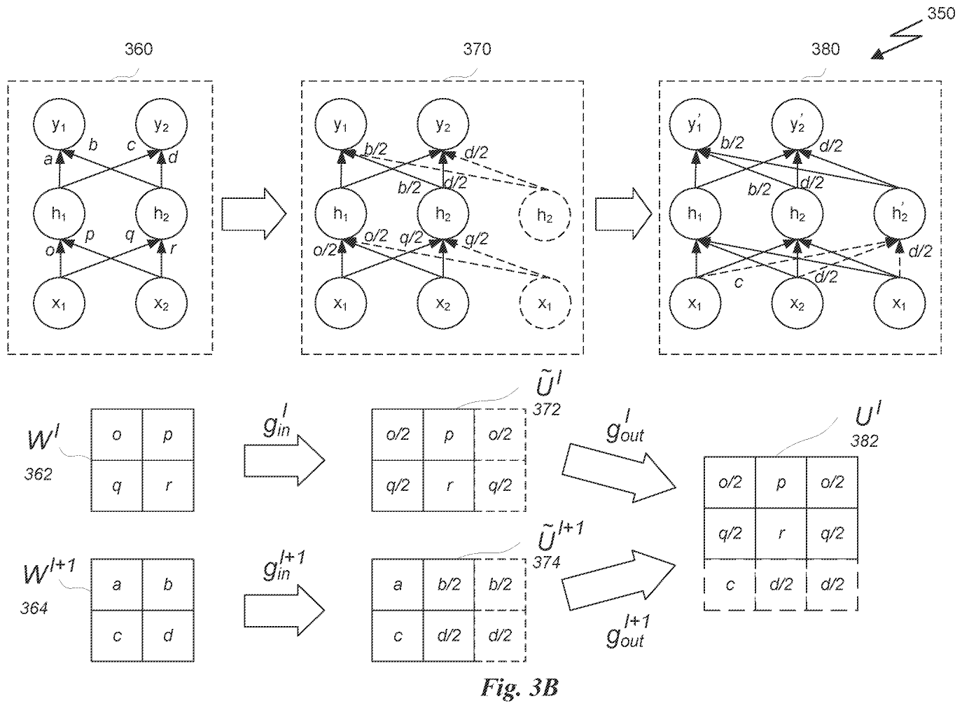

FIG. 3A is an exemplary process 300 of expanding a first parameter matrix W associated with the source model to generate a second parameter matrix U associated with the target model. Process 300 may be performed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform process 300. Process 300 may be performed alone or in combination with other processes in the present disclosure. It will be appreciated by one skilled in the art that process 300 may be performed in any suitable environment and blocks in process 300 may be performed in any suitable order.

In this example, the source model has a simplified architecture, which includes six nodes (e.g., neurons) in three layers, i.e., an input layer, a hidden layer, and an output layer. As shown in block 310, the input layer includes two nodes, which takes {x₁, x₂} as inputs. The hidden layer includes two nodes, which generates hidden states {h₁, h₂}. The output layer includes two nodes, which produces {y₁, y₂} as outputs. The weighted connections associated with the nodes in the source model may be represented by the first parameter matrix W. The weights associated with the weighted connections in the source model are shown in block 310, which may be elements in the first parameter matrix W. In particular, a matrix (W^{l}) 312 may represent weighted connections from the two nodes in the input layer to the two nodes in the hidden layer. The elements in matrix W^{l} 312 may be queried by column indices dᵢₙ^{w} and row indices dₒᵤₜ^{w}.

The processing system may first apply an in-dimension expansion to matrix W^{l} 312 by using Equations 9a and 9b to obtain a corresponding intermediate matrix (Ũ^{l}) 322. The index mapping function gᵢₙ as shown in Equation 7a is applied, resulting in the left column in matrix W^{l} 312 being sampled for generating the additional column in intermediate matrix Ũ^{l} 322. The sampled column is also updated in intermediate matrix Ũ^{l} 322. This computation step is equivalent to adding a node associated with the input x₁ to the source model in block 310 to obtain an intermediate model in block 320. As shown in block 320, the added node and added weighted connections in the intermediate model are drawn with a dashed circle and dashed arrows, respectively, while only updated or added weights are shown. In intermediate matrix Ũ^{l} 322, the indices associated with the added node are drawn with dashed grid lines.

The processing system may then apply an out-dimension expansion to intermediate matrix Ũ^{l} 322 by using Equation 9c to obtain a matrix U^{l} 332. The index mapping function gₒᵤₜ as shown in Equation 7b is applied, resulting in the bottom row in intermediate matrix Ũ^{l} 322 being sampled for generating the additional row in matrix U^{l} 332. This computation step is equivalent to adding a node associated with the hidden state h₂ to the intermediate model in block 320 to obtain the target model in block 330. As shown in block 330, the added node and added weighted connections in the target model are drawn with a dashed circle and dashed arrows, respectively, while only updated or added weights are shown. In matrix U^{l} 332, the indices associated with the added node are drawn with dashed grid lines. In block 330, the weighted connections between the added node and the nodes in the output layer are also updated, which are not shown in matrix U^{l} 332. In this way, the source model in block 310 may be expanded to obtain the target model in block 330 by applying FPI. The resulting target model in block 330 may receive {x₁, x₂} as inputs to the three nodes in its input layer and produce {y₁, y₂} as outputs, thereby preserving the functional properties of the source model in block 310.

In another example, the processing system may use a set of index mapping functions gᵢₙ and gₒᵤₜ to achieve advanced knowledge initialization (AKI). AKI uses not only the parameters in the current layer but also parameters in an upper layer (a layer after the current layer) to expand the source model, thereby avoiding redundancy in the expanded model and improving the converging rate. For instance, the processing system may use the current layer (W^{l}) and the next layer (W^{l+1}) in the source model to expand the current layer in the target model. That said, AKI may be defined as:

U^{l}=EXPN(W^{l},W^{l+1};gᵢₙ^{l|l+1},gₒᵤₜ^{l}). (Eq. 10)

Similarly, the weight expansion as defined by Equation 10 may include in-dimension and out-dimension expansions. The in-dimension expansion is similar to Equations 7a and 7b for FPI, with the modified notation as:

$$\begin{matrix}{C}_{{g}_{in}^{l} ( i )} = {\sum }_{{i}^{′} = 1}^{{d}_{in}^{u}} 𝕀 ( {g}_{in}^{l} ( {i}^{′} ) = {g}_{in}^{l} ( i ) ) , & ( Eq . 11 a ) \\ {\tilde{U}}_{( i , \text{*)}}^{l} = \frac{1}{{C}_{{g}_{in}^{l} ( i )}} {W}_{( {g}_{in}^{l} , \text{*)}}^{l} , & ( Eq . 11 b )\end{matrix}$$

The out-dimension expansion may be formulated as:

$${U}_{\text{(*} , j )}^{l} = \{ \begin{matrix}{\tilde{U}}_{\text{(*} , j )}^{l} & j ∈ [ 1 , {d}_{out}^{w} ] \\ {\tilde{U}}_{\text{(*} , {g}_{out}^{l} )}^{l + 1} & j ∈ ( {d}_{out}^{w} , {d}_{out}^{in} ]\end{matrix} . \qquad ( Eq . 12 )$$

In this way, the final matrix U^{l} may be constructed by stacking the expanded matrices Ũ^{l} and Ũ^{l+1}.

FIG. 3B is an exemplary process 350 of expanding a first parameter matrix W associated with the source model to generate a second parameter matrix U associated with the target model. Process 350 may be performed by a processing system including one or more computer systems 150 as illustrated in FIG. 1B, which may be embodied as one or more client devices 120, one or more servers 130, or a combination thereof in network environment 100 as depicted in FIG. 1A. Process 350 may be performed alone or in combination with other processes in the present disclosure. It will be appreciated by one of skilled in the art that process 350 may be performed in any suitable environment and blocks in process 350 may be performed in any suitable order.

In this example, the source model as shown in block 360 is the same as the source model in block 310 as shown in FIG. 3A. Similarly, a matrix (W^{l}) 362 may represent weighted connections from the two nodes in the input layer to the two nodes in the hidden layer. Additionally, a matrix (W^{l+1}) 364 may represent weighted connections from the two nodes in the hidden layer to the two nodes in the output layer.

The processing system may first apply in-dimension expansions to matrix W^{l} 362 and to matrix W^{l+1} 364 by using Equations 11a and 11b to obtain corresponding intermediate matrices (Ũ^{l}) 372 and (Ũ^{l+1}) 374, respectively. The index mapping function gᵢₙ as shown in Equation 7a is applied, resulting in the left column in matrix W^{l} 362 being sampled for generating the additional column in intermediate matrix Ũ^{l} 372 and the right column in matrix W^{l+1} 364 being sampled for generating the additional column in intermediate matrix Ũ^{l+1} 374. The sampled columns in the respective intermediate matrices are also updated. This computation step is equivalent to adding a node associated with the input x₁ and adding a node associated with the hidden state h₂ to the source model in block 360 so as to obtain the intermediate model in block 370. As shown in block 370, the added nodes and added weighted connections in the intermediate model are drawn with dashed circles and dashed arrows, respectively, while only updated or added weights are shown. In intermediate matrices Ũ^{l} 372 and Ũ^{l+1} 374, the indices associated with the added nodes are drawn with dashed grid lines.

The processing system may then apply out-dimension expansions to intermediate matrices Ũ^{l} 372 and Ũ^{l+1} 374 by using Equation 12 to obtain a matrix U^{l} 382. The index mapping function gₒᵤₜ used in AKI may sample the rows in intermediate matrix Ũ^{l+1} 374, which may provide more advanced knowledge than intermediate matrix Ũ^{l} 372. In this example, the bottom row is sampled for generating the additional row in matrix U^{l} 382. This computation step is equivalent to adding additional weighted connections to connect the added node in the hidden layer with the nodes in the input layer to obtain the target model in block 380. As shown in block 380, the added weighted connections in the target model are drawn with dashed arrows, while only added weights are shown. In matrix U^{l} 382, the indices associated with the added weighted connections are drawn with dashed grid lines. In this way, the source model in block 360 may be expanded to obtain the target model in block 380 by applying AKI. Unlike the target model in block 330 as shown in FIG. 3A, when the resulting target model in block 380 receives {x₁, x₂} as input to the three nodes in its input layer, the target model in block 380 generates a different set of hidden states {h₁, h₂, h′₂} and produces {y₁, y′₂} as output. In other words, the target model in block 380 does not preserve the functional properties of the source model in block 360.

Experiments revealed that adjacent transformer layers have similar functionalities, thus ensuring that the knowledge contained in parameters (e.g., weights) in the current layer may not be “damaged” by coupling with parameters from an adjacent layer. That is, the new current layer does not produce outputs that significantly deviate from the original current layer. Therefore, AKI can provide efficient knowledge transfer from the source model to the target model. In addition, AKI may provide additional benefits. First, knowledge from adjacent layers may break symmetry caused by FPI in the target model, thereby improving convergency rate of the target model. For instance, FPI may lead to the generation of repeated attention patterns in the same layer, which is redundant and is referred to as symmetry. Second, when an upper-layer is used in model expansion via AKI, the corresponding upper-layer information provide similar but more advanced (i.e., higher-level) knowledge than the current layer, thereby guiding the target model to converge faster.

FPI may ensure that the initialized target model has almost the same behavior as the source model, so that the target model has a good starting point for later optimization. On the other hand, AKI does not follow the principle of function preserving as FPI, but is still able to provide a good starting point for later optimization, which is supported by empirical results. Furthermore, AKI may lead to a faster convergence rate and achieve higher efficiency in training. The processing system may implement FPI and AKI individually or in combination to initialize a target model based on a source model. In addition, KPI and/or AKI may be combined with other techniques to further improve the training process.

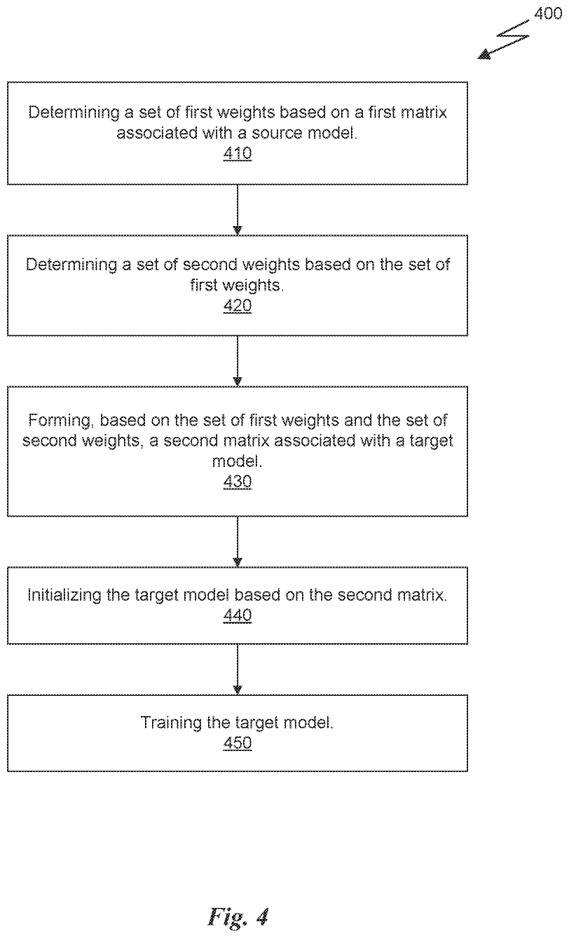

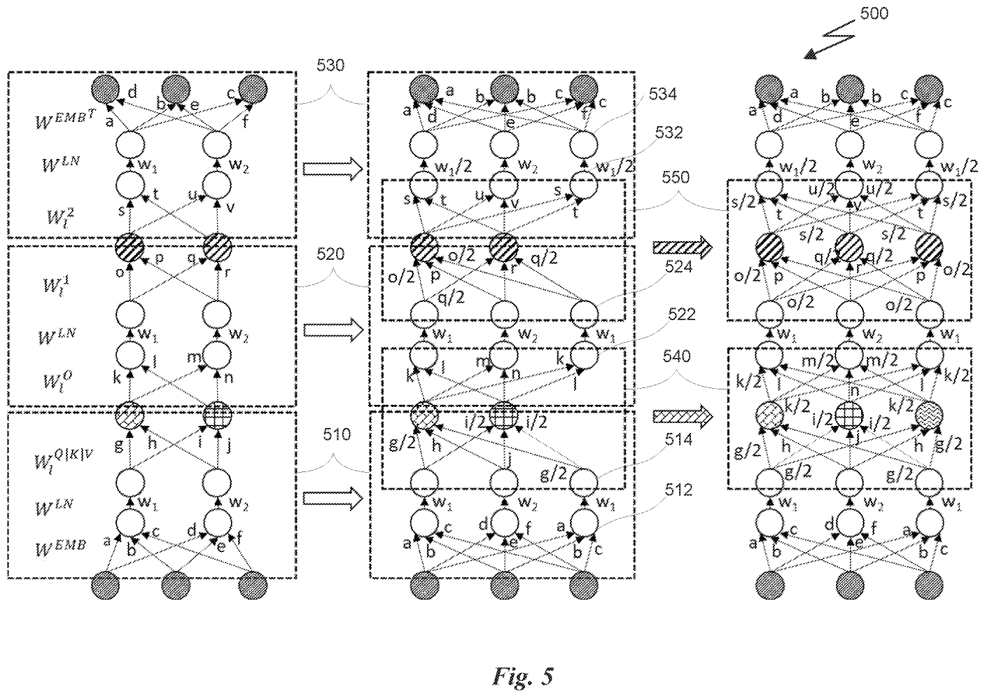

FIG. 4 is an exemplary process 400 of training a target model based on a source model, in accordance with one or more examples of the present disclosure. Process 400 may be performed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform process 400. Process 400 may be performed alone or in combination with other processes in the present disclosure. It will be appreciated by one skilled in the art that process 400 may be performed in any suitable environment and blocks in process 400 may be performed in any suitable order.

The source model may include a plurality of layers of many connected nodes. The connections of nodes in a pair of adjacent layers may be represented by a first matrix, where each element in the first matrix may be associated with an arrow connection between two nodes in the pair of adjacent layers.

At block 410, the processing system determines a set of first weights based on the first matrix associated with a source model. The processing system may apply in-dimension expansions, for example by applying Equation 7a, in the step of determining the set of first weights. The set of first weights may be associated with one or more first nodes added to a first layer of the source model. Each added first node may be connected to the nodes in the adjacent upper layer (e.g., the layer next to the first layer), where first weights associated with the respective added first node represent the weighted connections therebetween. The processing system may determine first weights associated with an added first node in the first layer of the model based on weighted connections of another node in the same layer. For example, in FIG. 3A, the processing system may determine the additional column of weights in matrix Ũ^{l} 322 for the added node associated with the input “x₁” based on the weights associated with the existing node associated with the input “x₁” as shown in block 320. The processing system may compute the first weights by applying Equations 9a and 9b. In some variations, the processing system may compute first weights for first nodes added to different first layers in the source model in parallel. For instance, the processing system may apply Equations 11a and 11b to compute the first weights associated with different layers in the source model.

Referring back to FIG. 4, at block 420, the processing system determines a set of second weights based on the set of first weights. The processing system may apply out-dimension expansions in the step of determining the set of second weights. The set of second weights may be associated with one or more second nodes added in the adjacent upper layer of the current layer in the source model. Each added second node may be connected to the nodes in the first layer with weighted connections based on the second weights associated with the respective added second node. In an example, the processing system may determine second weights associated with an added second node in the second layer of the model based on weighted connections between another node in the adjacent upper layer and the nodes in the first layer. As shown in FIG. 3A, the processing system may determine the additional row of weights in matrix U^{l} 332 for the added second node associated with the hidden state “h₂” based on the weights associated with the existing node associated with the hidden state “h₂” as shown in block 330.

In another example, the processing system may compute first weights for first nodes added to different first layers in the model in parallel. As shown in FIG. 3B, the processing system may determine the additional column of weights in matrix Ũ^{l} 372 for the added first node associated with the input “x₁” based on the weights associated with the existing node associated with the input “x₁” as shown in block 370. Meanwhile, the processing system may determine the additional column of weights in matrix Ũ^{l+1} 374 for the added first node associated with the hidden state “h₂” based on the weights associated with the existing node associated with the hidden state “h₂” as shown in block 370. In this example, layer-l may be defined as the current layer. Accordingly, layer-(l+1) is the adjacent upper layer of the current layer, and the added node in the hidden layer is considered as a second node when performing out-dimension expansion for the current layer. Further, layer-(l+2) is the adjacent upper layer of the layer-(l+1). The processing system may determine the additional row of weights in matrix U^{l} 382 for the added second node associated with the hidden state “h′₂” based on the weights associated with the existing node associated with the output “y′₂” in the adjacent upper layer of the layer-(l+1) as shown in block 380. In this way, the processing system may determine the set of second weights.

Referring back to FIG. 4, at block 430, the processing system forms a second matrix associated with the target model based on the set of first weights and the set of second weights. In some examples, the processing system may first obtain a widened model based on the source model by applying blocks 410-430 of process 400, and then iteratively stack the widened model to obtain the target model.

The processing system may repeat some or all of blocks 410-430 for multiple iterations to expand the second matrix to the target dimension of the target model, e.g., from the source model [symbol] (L^{s}, D^{s}) to the target model [symbol] (L^{t}, D^{t}).

At block 440, the processing system initializes the target model based on the second weight matrix.

At block 450, the processing system trains the target model. In some variations, the processing system may use the trained target model as a second source model to initialize a second target model by repeating process 400.

Processes in the present disclosure may be performed to expand various functional modules in a neural network model. The following examples demonstrate implementation of the above-described FPI/AKI for expansions of different modules in a BERT model having an architecture as shown in FIG. 2A.

FIG. 5 is a flowchart 500 of performing expansions via FPI on various functional modules in a BERT model, in accordance with one or more examples of the present disclosure. Flowchart 500 may be executed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to execute flowchart 500.

In this example, the left model is the source model, the middle one is an intermediate model, and the right one is the target model. The BERT model may include multiple functional modules, such as the networks as shown in blocks 510, 520, and 530. Each functional module may include a plurality of layers of multiple connected neurons (i.e., nodes). For example, from bottom to top, block 510 of the source model includes three embedding neurons in the lowest layer, two neurons in each of the two hidden layers, and two neurons for two different attention heads in the highest layer. Block 520 of the source model includes the two neurons for two different attention heads in the lowest layer, two neurons in each of the two hidden layers, and two FFN neurons in the highest layer. Block 530 of the source model includes the two FFN neurons in the lowest layer, two neurons in each of the two hidden layers, and three embedding neurons in the highest layer. The intermediate model and the target model may have a similar architecture as the source model, but with different dimensions. Weights associated with arrow connections between neurons in adjacent layers are shown in the models as shown in FIG. 5. Furthermore, weights associated with arrow connections between neurons in a pair of adjacent layers may be associated with a parameter/weight matrix, such as W^{EMB}, W^{LN}, etc.

As shown in FIG. 5, from the source model to the intermediate model, the processing system may expand the hidden layers in blocks 510, 520, and 530. As a result, the processing system may add additional neurons 512 and 514 in block 510, add additional neurons 522 and 524 in block 520, and add additional neurons 532 and 534 in block 530. From the intermediate model to the target model, the processing system may expand the layer of neurons for attention heads in block 540, and may expand the layer of FFN neurons in block 550. Similarly, the processing system may add an additional neuron for an additional attention head in block 540, and add an additional FFN neuron in block 550. As demonstrated in exemplary BERT model architecture 200 in FIG. 2A, BERT model may include a plurality of transformer layers 220, where each transformer layer may include MHA module 222 and FFN 232. In this example, block 540 may be associated with MHA module 222, block 550 may be associated with FFN 232, and both blocks 540 and 550 may be included in one transformer layer. The embodiment of FIG. 5 may be applied to other transformer layers in the plurality of transformer layers, which are not shown in this figure for simplicity.

The updated weights in the intermediate/target model may be determined by applying the aforementioned in-dimension and/or out-dimension expansions to the corresponding parameter/weight matrices. In this example, the processing system may compute the expanded embedding matrix U^{E} based on the original embedding matrix W^{E} by applying the following:

U_{(*,j)}^{E}=W_{(*,g}_{ₒᵤₜ}_{^{e}}₍ⱼ₎₎^{E}, (Eq. 13)

where only out-dimension expansion is applied.

The processing system may compute the head-wise expansion by applying the following:

U^{Q|K|V|O}=EXPN(W^{Q|K|V|O};gᵢₙ^{q|k|v|o},gₒᵤₜ^{q|k|v|o}), (Eq. 14)

which results in an increased number of attention heads. By applying head-wise expansion, the existing head group parameters may be reused to construct new matrices. For instance, the i^{th} head group in the l^{th} layer may include parameter/weight matrices W_{l,i}^{Q}|W_{l,i}^{K}|W_{l,i}^{V}|W_{l,i}^{O} as described in Equations 2a-2c, and 3. Accordingly, the out-dimension expansion for the matrices W_{l,i}^{Q}|W_{l,i}^{K}|W_{l,i}^{V} may be formulated as:

$${g}_{out}^{q \vert k \vert v} ( j ) = \{ \begin{matrix}j & j ∈ [ 1 , {a}^{s} ] \\ f ( \{ 1 , 2 , … , {a}^{s} \} ) & j ∈ ( {a}^{s} , {a}^{t} ]\end{matrix} , \qquad ( Eq . 15 )$$

where j is the index of the attention head, a^{s|t} indicates the respective number of attention heads in the source/target model. Three constraints may be applied for expansion of the MHA module, which are expressed as: {gₒᵤₜ^{e}=gᵢₙ^{q|k|v}; gₒᵤₜ ^{q|k|v}=gᵢₙ^{o}; gᵢₙ^{q|k|v}=gₒᵤₜ^{o}}. The first two constraints may be used to keep hidden layer dimensions consistent, while the third one may be used for seamless residual connections.

For the FFN module, the processing system may compute the expansions to the parameter matrices W^{1|2} as:

U^{1|2}=EXPN(W^{1|w};gᵢₙ^{1|2};gₒᵤₜ^{1|2}). (Eq. 16)

Similar to the MHA module, three constraints may be applied for expansion of the FFN module, which are expressed as: {gₒᵤₜ^{o}=gᵢₙ¹; gₒᵤₜ¹=gᵢₙ²; gᵢₙ¹=gₒᵤₜ²}.

For layer normalization, the processing system may compute the expansions to the parameter matrices W^{LN} in the different modules by applying only out-dimension expansions. For instance, expansion of the layer normalization in the FFN module may be computed as Uⱼ^{LN}=W_{g}_{ₒᵤₜ}_{²}₍ⱼ₎^{LN}. The aforementioned Equation 6 defines the process of layer normalization, in which a mean μ and a variance σ are calculated based on the hidden representations in the matrix H. Thus, expansions of the parameter matrices W^{LN} inevitably induce a gap and therefore, hinder the target model from strictly following the function preserving principle. Yet, empirical results show that the gap is so small that it hardly affects the initialization and convergence of the target model. In fact, the initialized target model can achieve almost the same loss as the source model, thus successfully preserving the knowledge of the source model.

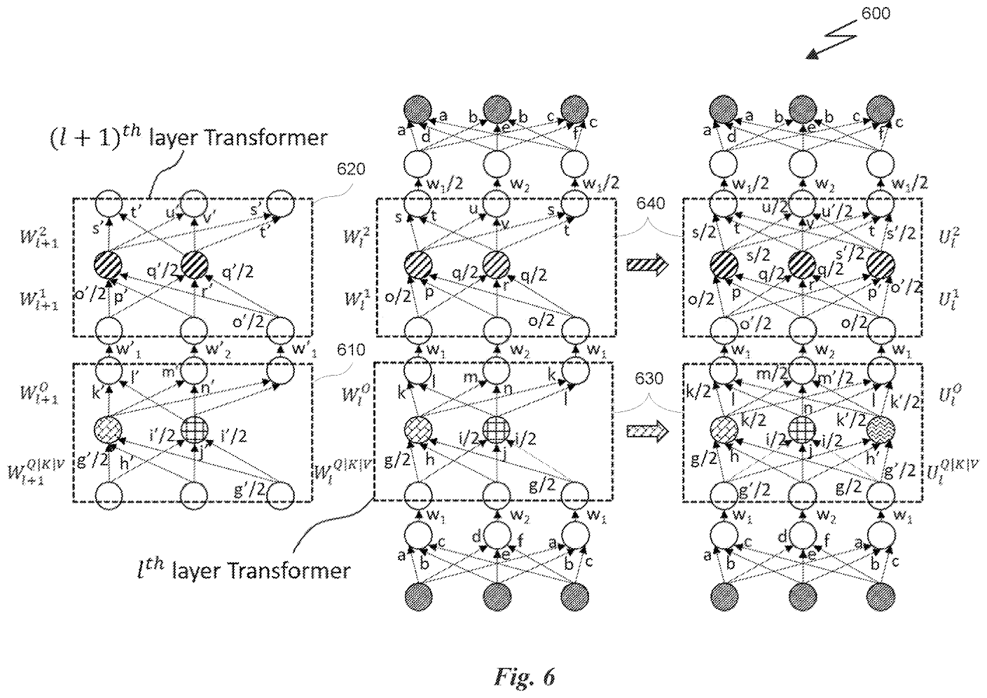

FIG. 6 is a flowchart 600 of performing expansions via AKI on various functional modules in the BERT model as shown in FIG. 5, in accordance with one or more examples of the present disclosure. Flowchart 600 may be executed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to execute flowchart 600.

In this example, an additional transformer layer is presented, which is used for expanding the current transformer layer. The current transformer layer is the l^{th} transformer layer, and the additional transformer layer is the layer above the current transformer layer, that is, the (l+1)^{th} transformer layer. The l^{th} transformer layer may include block 630 associated with MHA module 222 and block 640 associated with FFN 232. Similarly, the (l+1)^{th} transformer layer may include block 610 associated with MHA module 222 and block 620 associated with FFN 232.

As shown in FIG. 6, the intermediate model in the middle demonstrates expanded hidden layers in blocks 510, 520, and 530 in the l^{th} transformer layer in the source model (i.e., the left model in FIG. 5). Similar expansions may be applied to the (l+1)^{th} transformer layer in the source model, resulting in the (l+1)^{th} transformer layer shown on the left side of FIG. 6, also included in the intermediate model. From the intermediate model to the target model (i.e., the right model in FIG. 6), the processing system may expand the layer of neurons for attention heads in block 630, and may expand the layer of FFN neurons in block 640. As a result, the processing system may add an additional neuron for an additional attention head in block 630, and add an additional FFN neuron in block 640. The additional arrow connections in the l^{th} transformer layer in the target model may be determined based on existing arrow connections in the (l+1)^{th} transformer layer in the intermediate model. For instance, arrow connections associated with the additional neuron for the additional attention head in block 630 in the target model may be determined based on arrow connections associated with the left/right neuron for the corresponding attention head in block 610 in the l^{th} transformer layer in the intermediate model. Arrow connections associated with the additional FFN neuron in block 640 in the target model may be determined based on arrow connections associated with the left/right FFN neuron in block 620 in the l^{th} transformer layer in the intermediate model.

The processing system may apply the same out-dimension expansions, i.e., the Equation 13, to the embedding matrix as the process described in flowchart 500. The processing system may compute expanded matrices for both the MHA and FFN modules by applying Equations 11a, 11b, and 12. The constraints of the mapping functions may follow the settings in flowchart 500, which are associated with FPI.

In some embodiments, the processing system may perform depth-wise expansion to increase the depth of the expanded model to reach the target depth of the target model. Various techniques may be used. For instance, the processing system may iteratively stack certain layers in the model that are expanded via width-wise expansions. In other words, depth-wise expansion may be performed after width-wise expansion, by duplicating certain widened layers to satisfy the target depth of the target model. The bottom layers in the model may be used for replication. Table 1 demonstrates an exemplary algorithm implementing depth-wise expansions, which may be executed by processer(s) 160 in the processing system by executing instructions stored in memory 180.

TABLE 1
an exemplary algorithm for target model initialization.

```
Algorithm 1 Target Model Initialization
Input: a target model [symbol]   (L^{t}, D^{t}) and a source model [symbol]   (L^{s}, D^{s}).
  1: [symbol]  ₁(L^{t}, D^{t}) ← do AKI or FPI with [symbol]   (L^{s}, D^{s})
  2: k ← └L^{t}/L^{s}┘
  3: for t = 2 → k do
  4: [symbol]   ₜ (L^{t} · t, D^{t}) ← stack [symbol]  ₁ on top of [symbol]  ₜ₋₁
  5: end for
  6: [symbol]   ← stack top L^{t} − L^{s} · k layers of [symbol]  ₁.
Output: the initialized model [symbol]   (L^{t}, D^{t})
```

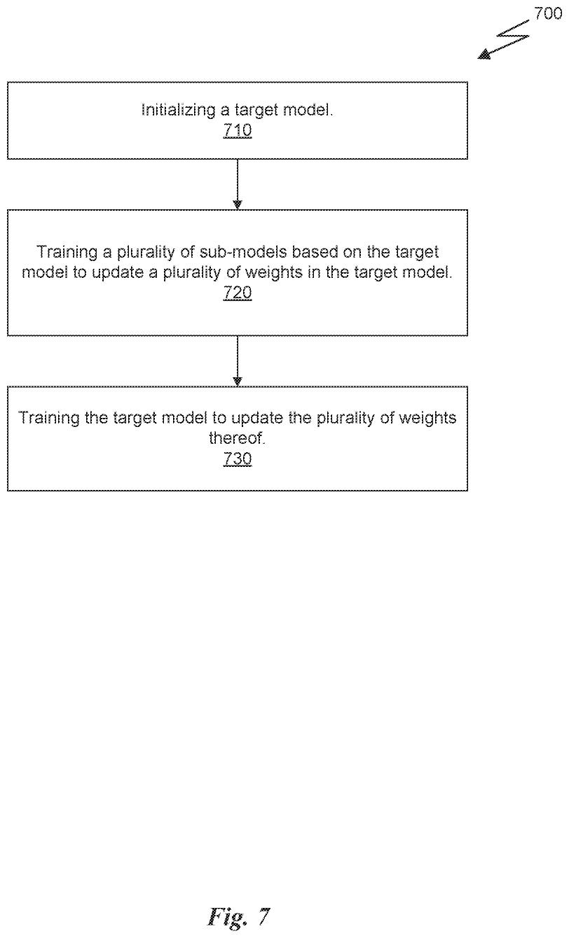

In some embodiments, a two-stage training strategy may be implemented to further accelerate the training process of the target model. FIG. 7 is an exemplary process 700 of training a target model by implementing two-stage training, in accordance with one or more examples of the present disclosure. Process 700 may be performed by a processing system including one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform process 700. Process 700 may be performed alone or in combination with other processes in the present disclosure. It will be appreciated by one skilled in the art that process 700 may be performed in any suitable environment and in any suitable order.

At block 710, the processing system initializes a target model. The processing system may use a source model to determine initial weights (or parameters) for the target model by performing any of the processes in the present disclosure.

At block 720, the processing system trains a plurality of sub-models based on the target model to update a plurality of weights in the target model. The processing system may first generate the plurality of sub-models based on the target model. Each sub-model among the plurality of sub-models may include a subset of layers in the target model. During training, all or some of the layers in the subset of layers of the corresponding sub-model may be updated. The plurality of sub-models may be trained to updated different layers in the target model.

In some instances, the processing system may train the plurality of sub-models in a random manner, so that different layers in the target model may be randomly updated, thereby achieving complete coverage of the target model at low cost. For example, in an exemplary BERT model with nine transformer layers, three sub-models may be built with different numbers of transformer layers and may share one classification layer that is on top of the transformer layers. The first sub-model may include the bottom three transformer layers among the nine transformer layers, the second sub-model may include the bottom six transformer layers among the nine transformer layers, and the third sub-model may include the nine transformer layers. At each optimization (i.e., training) step, the processing system may randomly sample a sub-model among the three sub-models. When the first sub-model is sampled, the processing system may update the three transformer layers in the first sub-model and the classification layer. When the second sub-model is sampled, the processing system may use all six transformer layers for calculating a training loss and then may update top three transformer layers in the second sub-model and the classification layer based on the calculated training loss. When the third sub-model is sampled, the processing system may use all nine transformer layers for calculating a training loss and then may update top three transformer layers in the third sub-model and the classification layer based on the calculated training loss.

At block 730, the processing system trains the target model to update the plurality of weights thereof.

Table 2 demonstrates an exemplary algorithm implementing the two-stage training, which may be executed by processer(s) 160 in the processing system by executing instructions stored in memory 180.

TABLE 2
an exemplary algorithm for two-stage pre-training.

Algorithm 2 Two-stage Pre-training
Input: an initialized model [symbol] , a large-scale unsupervised dataset [symbol] ,
an epoch number of sub-model training E_{b} and the epoch number
of the whole training process E, a layer number l_{b}.
1: Construct sub-models and the sub-models have the layer
numbers of {l_{b}, 2 · l_{b}, ... , L^{t}}.
2: for e = 1 → E_{b} do
3: for batch in [symbol] do
4: [symbol] ′ ← sample on sub-model.
5: Perform forward and backward of [symbol] ′.
6: Update only top l_{b} layers of [symbol] ′.
7: end for
8: end for
9: for e = E_{b} → E do
10 for batch in [symbol] do
11: Perform forward and backward of [symbol] .
12: Update whole model [symbol] .
13: end for
14: end for
Output: the pre-trained model

[symbol]

Additional details and advantages relating to exemplary embodiments of the present disclosure are discussed in Appendix A.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods/processes described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for model training, performed by a processing system, comprising:
a) determining a set of first weights based on a first matrix associated with a source model;
b) determining a set of second weights based on the set of first weights;
c) forming, based on the set of first weights and the set of second weights, a second matrix associated with a target model;
d) initializing the target model based on the second matrix; and
e) training the target model.

2. The method according to claim 1, wherein the first matrix comprises weights associated with connections between nodes in a current layer and nodes in an upper layer in the source model, and wherein determining a set of first weights based on a first matrix associated with a source model further comprises:
sampling weights associated with the nodes in the current layer among the weights in the first matrix;
determining the set of first weights based on the sampled weights associated with one node among the nodes in the current layer; and
forming a first intermediate matrix based on the set of first weights and the first matrix,
wherein determining a set of second weights based on the set of first weights is based on the intermediate matrix.

3. The method according to claim 2, wherein determining a set of second weights based on the set of first weights further comprises:
sampling weights associated with the nodes in the upper layer among the weights in the first intermediate matrix; and
determining the set of second weights based on the sampled weights associated with one node among the nodes in the upper layer,
wherein forming, based on the set of first weights and the set of second weights, a second matrix associated with a target model further comprises:
forming the second matrix based on the first intermediate matrix and the set of second weights.

4. The method according to claim 2, wherein the current layer is comprised in a multi-head attention (MHA) module in a transformer network, the nodes in the current layer are neurons for multiple attention heads.

5. The method according to claim 2, wherein a third matrix comprises weights associated with connections between the nodes in the upper layer and nodes in a third layer in the source model, wherein the third layer is the next layer of the upper layer, the method further comprising:
sampling weights associated with the nodes in the upper layer among the weights in the third matrix;
determining a set of third weights based on the sampled weights associated with one node among the nodes in the upper layer; and
forming a second intermediate matrix based on the set of third weights and the third matrix.

6. The method according to claim 5, wherein determining a set of second weights based on the set of first weights further comprises:
sampling weights associated with the nodes in the third layer among the weights in the second intermediate matrix; and
determining the set of second weights based on the sampled weights associated with one node among the nodes in the third layer,
wherein forming, based on the set of first weights and the set of second weights, a second matrix associated with a target model further comprises:
forming the second matrix based on the first intermediate matrix and the set of second weights.

7. The method according to claim 1, further comprising:
f) generating multiple copies of the second matrix by duplicating the second matrix multiple times,
wherein initializing the target model based on the second matrix further comprises:
initializing the target model using the multiple copies of the second matrix.

8. The method according to claim 7, further comprising:
obtaining the copies of the second matrix of target dimensions for the target model by carrying out multiple iterations of a), b), c), and f).

9. The method according to claim 1, wherein the first matrix is associated with one module among a plurality of modules in the source model, the method further comprising;
forming, by carrying out multiple iterations of a) through c), a second matrix associated with each of the other modules among the plurality of models in the source model.

10. The method according to claim 1, wherein the trained target model is used as a second source model to initialize a second target model.

11. The method according to claim 1, wherein training the target model further comprises:
determining a plurality of sub-models based on the target model, wherein the target model comprises a plurality of layers and each sub-model is used for updating a subset of layers among the plurality of layers in the target model;
updating the plurality of layers in the target model by training the plurality of sub-models; and
training the target model to update the plurality of layers thereof.

12. The method according to claim 11, wherein updating the plurality of layers in the target model by training the plurality of sub-models further comprises:
sampling the plurality of sub-models;
training the sampled sub-model by using a training dataset; and
updating a corresponding subset of layers among the plurality of layers in the target model.

13. The method according to claim 12, wherein each of the plurality of sub-models comprises all or part of the plurality of layers in the target model,
wherein the subset of layers in the corresponding sub-model is a portion or all of the layers in the corresponding sub-model; and
wherein training the sampled sub-model by using a training dataset further comprises:
computing, by using all of the layers in the corresponding sub-model, a training loss based on the training dataset; and
updating the subset of layers in the corresponding sub-model based on the training loss.

14. A system for model training, comprising:
one or more processors; and
a non-transitory computer-readable medium, having computer-executable instructions stored thereon, the computer-executable instructions, when executed by one or more processors, causing the one or more processors to facilitate:
a) determining a set of first weights based on a first matrix associated with a source model;
b) determining a set of second weights based on the set of first weights;
c) forming, based on the set of first weights and the set of second weights, a second matrix associated with a target model;
d) initializing the target model based on the second matrix; and
e) training the target model.

15. The system according to claim 14, wherein the first matrix comprises weights associated with connections between nodes in a current layer and nodes in an upper layer in the source model, and wherein determining a set of first weights based on a first matrix associated with a source model further comprises:
sampling weights associated with the nodes in the current layer among the weights in the first matrix;
determining the set of first weights based on the sampled weights associated with one node among the nodes in the current layer; and
forming a first intermediate matrix based on the set of first weights and the first matrix,
wherein determining a set of second weights based on the set of first weights is based on the intermediate matrix.

16. The system according to claim 15, wherein determining a set of second weights based on the set of first weights further comprises:
sampling weights associated with the nodes in the upper layer among the weights in the first intermediate matrix; and
determining the set of second weights based on the sampled weights associated with one node among the nodes in the upper layer,
wherein forming, based on the set of first weights and the set of second weights, a second matrix associated with a target model further comprises:
forming the second matrix based on the first intermediate matrix and the set of second weights.

17. The system according to claim 15, wherein a third matrix comprises weights associated with connections between the nodes in the upper layer and nodes in a third layer in the source model, wherein the third layer is the next layer of the upper layer, and wherein the one or more processors further facilitate:
sampling weights associated with the nodes in the upper layer among the weights in the third matrix;
determining a set of third weights based on the sampled weights associated with one node among the nodes in the upper layer; and
forming a second intermediate matrix based on the set of third weights and the third matrix.

18. The system according to claim 17, wherein determining a set of second weights based on the set of first weights further comprises:
sampling weights associated with the nodes in the third layer among the weights in the second intermediate matrix; and
determining the set of second weights based on the sampled weights associated with one node among the nodes in the third layer,
wherein forming, based on the set of first weights and the set of second weights, a second matrix associated with a target model further comprises:
forming the second matrix based on the first intermediate matrix and the set of second weights.

19. The system according to claim 1, wherein training the target model further comprises:
determining a plurality of sub-models based on the target model, wherein the target model comprises a plurality of layers and each sub-model is used for updating a subset of layers among the plurality of layers in the target model;
updating the plurality of layers in the target model by training the plurality of sub-models; and
training the target model to update the plurality of layers thereof.

20. A non-transitory computer-readable medium, having computer-executable instructions stored thereon, for model training, the computer-executable instructions, when executed by one or more processors, causing the one or more processors to facilitate:
a) determining a set of first weights based on a first matrix associated with a source model;
b) determining a set of second weights based on the set of first weights;
c) forming, based on the set of first weights and the set of second weights, a second matrix associated with a target model;
d) initializing the target model based on the second matrix; and
e) training the target model.
